(19) United States
(12) Patent Application Publication
(10) Pub. No.: US 2014/0224958 A1
(43) Pub. Date: Aug. 14, 2014

(54) COATINGS FOR GLASS-SHAPING MOLDS AND GLASS-SHAPING MOLDS COMPRISING THE SAME

(71) Applicant: CORNING INCORPORATED, Corning, NY (US)

(72) Inventors: Jiangwei Feng, Painted Post, NY (US); Lin Lin, Corning, NY (US); Ljerka Ukrainczyk, Painted Post, NY (US)

(73) Assignee: CORNING INCORPORATED, Corning, NY (US)

(21) Appl. No.: 14/175,313

(22) Filed: Feb. 7, 2014

Related U.S. Application Data
(60) Provisional application No. 61/763,170, filed on Feb. 11, 2013.

(51) Int. Cl. C03B 19/02

(52) U.S. Cl. CPC C03B 19/02
USPC 249/114.1; 427/133; 428/702; 428/698; 428/457

(57) ABSTRACT

A multi-layer coating for a glass-shaping mold is disclosed. The multi-layer coating may include a glass-contacting layer and a diffusion barrier layer. The glass-contacting layer may make contact with glass during glass-shaping and may include titanium oxide, aluminium oxide, or combinations thereof. The diffusion barrier layer may be positioned between the glass-contacting layer and a mold body and may restrict diffusion of base metals from the mold body to the glass-contacting layer and diffusion of glass materials from the glass-contacting layer to the mold body.

This application claims the benefit of priority under 35 U.S.C. §119 of U.S. Provisional Application Ser. No. 61/763,170 filed on Feb. 11, 2013, the content of which is relied upon and incorporated herein by reference in its entirety.

### BACKGROUND

1. Field

The present specification generally relates to glass-shaping molds and, more specifically, to coated glass-shaping molds.

2. Technical Background

Glass articles can be formed into 3D shapes by heating the glass to a visco-elastic state and contacting the glass with a mold. However, forming three-dimensionally shaped glass articles with high softening point glass compositions, such as alkali aluminosilicate glass compositions, can be challenging. For example, some glass compositions have high softening points (sometimes greater than 800° C.), which makes a precision molding process more difficult since the glass needs to be heated to higher temperatures in order to reach a visco-elastic state suitable to forming. Additionally, some glass compositions have high percentages of sodium (such as, for example, greater than 10 mol %). Sodium may be highly mobile and reactive at high temperatures. Contacting a mold surface with sodium at high temperature may degrade the mold surface and, subsequently, the quality of the molded glass. Furthermore, pitting in the glass may be caused by particulate contaminants, such as contaminants from the mold. Pitting may also be caused by glass sticking to the mold surface where the glass to mold bond strength exceeds the strength of glass, creating divots in the glass due to so called “pullouts”. Other cosmetic defects such as stains and/or scuffing may be observed on 3D molded glass surfaces, especially when using high forming temperatures and longer contact times. Additionally, coatings which may be applied to molds must be replaced periodically following a number of process cycles.

Accordingly, a need exists for alternative coatings for glass-shaping molds and glass-shaping molds comprising the same.

### SUMMARY

The embodiments described herein relate to coated glass-shaping molds and multi-layer coatings for glass-shaping molds. According to one embodiment, a multi-layer coating for a glass-shaping mold may comprise a glass-contacting layer and a diffusion barrier layer. The glass-contacting layer may make contact with glass during glass-shaping and may comprise titanium oxide, aluminium oxide, or combinations thereof. The diffusion barrier layer may be positioned between the glass-contacting layer and a mold body. The diffusion barrier layer may restrict diffusion of base metals from the mold body to the glass-contacting layer and diffusion of glass materials from the glass-contacting layer to the mold body.

In another embodiment, a coated mold for shaping glass may comprise a mold body and a multi-layer coating. The multi-layer coating may comprise a glass-contacting layer and a diffusion barrier layer. The glass-contacting layer may make contact with glass during glass-shaping and may comprise titanium oxide, aluminium oxide, or combinations thereof. The diffusion barrier layer may be positioned between the glass-contacting layer and a mold body. The diffusion barrier layer may restrict diffusion of base metals from the mold body to the glass-contacting layer and diffusion of glass materials from the glass-contacting layer to the mold body.

In yet another embodiment, a coated mold for shaping glass may be made. The coated mold may be made by depositing a multi-layer coating onto at least a portion of a forming surface of a mold body. Depositing the multi-layer coating may comprise depositing a diffusion barrier layer, depositing the glass-contacting layer, and heat treating the coated mold. The diffusion barrier layer may be positioned between a glass-contacting layer and the mold body and may restrict both diffusion of base metals from the mold body to the glass-contacting layer and diffusion of glass materials from the glass-contacting layer to the mold body. The glass-contacting layer may comprise titanium, aluminium, or combinations thereof. The coated mold may be heat treated by heating for a time and at a temperature sufficient to oxidize at least a portion of the multi-layer coating.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts the structure of a coated mold, according to one or more embodiments shown and described herein; and

FIG. 2 schematically depicts a cross sectional diagram of a multi-layer coating on a mold body, according to one or more embodiments shown and described herein.

### DETAILED DESCRIPTION

Reference will now be made in detail to various embodiments of coatings for glass-shaping molds, examples of which are illustrated in the accompanying drawings. Whenever possible, the same reference numerals will be used throughout the drawings to refer to the same or like parts. In one embodiment, a coated mold for glass-shaping may include a multi-layer coating positioned on at least a portion of a surface of a mold body. The multi-layer coating may generally include at least a glass-contacting layer and a diffusion barrier layer. The glass-contacting layer is positioned at the outermost surface of the multi-layer coating, so as to contact a heated glass that is positioned on the forming surface of the coated mold. The diffusion barrier layer is positioned between the glass-contacting layer and the mold body. The diffusion barrier layer restricts the diffusion of base metals from the mold body to the glass-contacting layer and the diffusion of glass materials from the glass-contacting layer to the mold body. The multi-layer coating may further comprise other intermediate layers, such as an adhesion layer positioned between the mold body and the diffusion barrier layer and/or a transition layer positioned between the glass-contacting layer and the diffusion barrier layer. Embodiments of multi-layer coatings for glass-shaping molds and glass-shaping molds comprising the same will be described in more detail herein with specific reference to the appended drawings.

Generally, the multi-layer coating is deposited onto the mold body using a deposition technique, such as physical vapor deposition (PVD). Various layers of the multi-layer coating, as described herein, may be deposited sequentially, beginning with the layer in direct contact with the mold body and ending with the glass-contacting layer positioned as the outermost layer of the multi-layer coating. Following the deposition of the layers, the coated mold may be subjected to a heat treatment, such as heating the coated mold to a temperature of at least about 500° C. The heat treatment may promote oxidation of at least some of the layers of the multi-layer coating. Unless specified otherwise herein, a “coated mold” or a “multi-layer coating” refers to the post-heat treatment state of the “coated mold” or “multi-layer coating”, respectively.

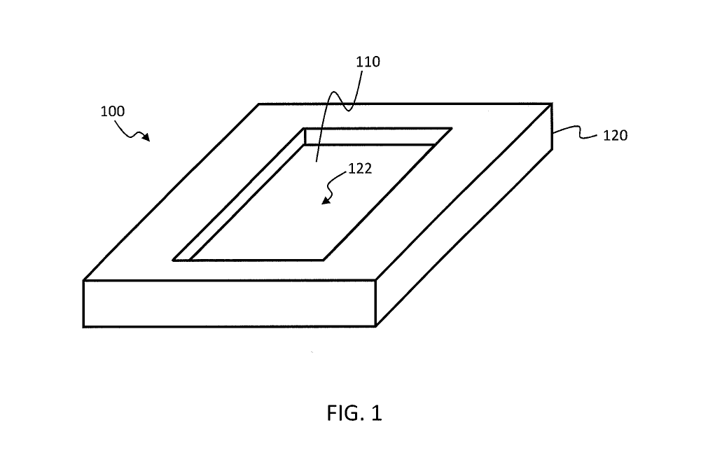

Referring to FIG. 1, a coated mold 100 for glass-shaping is depicted. The coated mold 100 may comprise a mold body 120 that may include a forming surface 122 disposed on the mold body 120. The multi-layer coating 110 may be positioned on at least a portion of the forming surface 122 of the mold body 120. In the embodiment shown in FIG. 1, the geometry of the forming surface 122 defines a cavity in the mold body 120. However, in other embodiments, the geometry of the forming surface 122 may define other shapes such as protruded areas of the mold body 120 that may make contact with the glass being formed. It should be understood that a wide variety of geometries of the mold body 120 may be used to form varying three dimensional glass articles. In some embodiments, more than one mold body may be utilized to form a glass article. For example, two mold bodies may make contact with opposite sides of a glass body to shape the glass body. Accordingly, in a two-mold embodiment, each mold body may comprise a forming surface which makes contact with the glass and is coated with a multi-layer coating 110, respectively.

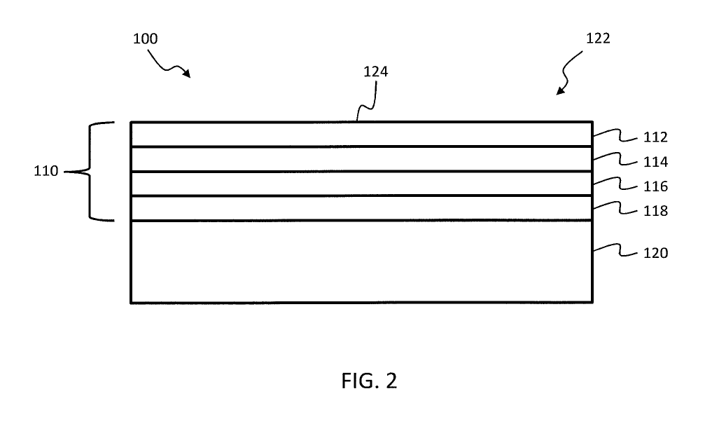

Referring now to FIG. 2, a cross sectional view of a portion of a coated mold 100 with a multi-layer coating 110 positioned on at least a portion of the mold body 120 at the forming surface 122 is schematically depicted. The multi-layer coating 110 generally includes a plurality of stacked coating layers 112,114,116,118. The multi-layer coating 110 includes at least a glass-contacting layer 112 and a diffusion barrier layer 116. During a molding operation, the glass is positioned in the area of the forming surface 122 and in contact with the glass-contacting surface 124 of the glass-contacting layer 112 of the multi-layer coating 110. The multi-layer coating 110 may optionally include other layers, such as an adhesion layer 118 and/or a transition layer 114. In one embodiment, an adhesion layer 118 is positioned directly on the surface of the mold body 120, and the diffusion barrier layer 116 is positioned on top of the adhesion layer 118. In some embodiments, a transition layer 114 may be positioned on top of the diffusion barrier layer 116, and a glass-contacting layer 112 may be positioned on top of the transition layer 114. As used herein, “top” or “outer” refer to a surface of a coating layer facing away from the mold body 120 and “bottom” or “inner” refer to a surface of a coating layer facing towards the mold body 120. For purposes of illustration only, the coating layers of FIG. 2 are uniform in thickness and are depicted as completely flat. However, this does not need be the case in embodiments of the coated mold 100 disclosed herein, as layers may be non-uniform in thickness and in shape. As used herein, a layer's thickness is the average thickness of the layer over the entire surface area that is coated. While FIG. 2 shows a multi-layer coating 110 with an adhesion layer 118, diffusion barrier layer 116, transition layer 114, and glass-contacting layer 112, the embodiments described herein may comprise any combination of one or more of these coating layers. Additionally, the coating layers may not have uniform compositions throughout their entire thickness, as some layers may have varying compositions throughout or even distinct sub-layers within identified layers.

The mold body 120 may be any suitable mold capable of shaping molten glass. Examples of molds include, but are not limited to, tools such as dies, or other manufacturing presses. The mold body 120 may comprise any metal or other material capable of withstanding high temperatures, such as refractory metals, refractory ceramics, or the like. For example, the mold body 120 may comprise a high temperature alloy with high hardness, such as, but not limited to, nickel-based alloys such as Inconel® 718 or other, similar high temperature alloys. Some molds bodies may comprise base metals, such as, for example, Ni or Cr, which may be mobile through diffusion to portions of a conventional coating, especially at elevated temperatures.

The glass, which is molded by contact with the coated mold 100 at the forming surface 122, may generally be any glass suitable for 3D forming. It is also contemplated herein that other ceramic materials and/or glass-ceramic materials may be shaped with the coated molds described herein. In some embodiments, the glass may be ion-exchangeable aluminosilicate glass. Examples of such ion-exchangeable aluminosilicate glass include, but are not limited to, Gorilla Glass® and Gorilla Glass II® (commercially available from Corning, Inc.). Such glass, especially after 3D molding, may be well suited for many uses, such as, for example, as cover glass for hand-held consumer electronic devices. During prolonged glass molding/re-forming cycles, close contact between glass and conventional molds at high temperature may cause diffusion of the glass materials into at least a mold coating and/or a mold body. Some glass components which may enter a mold material or a conventional coating are Na₂O, SiO₂, and Al₂O₃, as well as other out-diffused glass components. The buildup of these glass components on the surface of a non-coated mold cavity is undesirable, as it may lead to glass sticking to the conventional mold coating. This may further result in degrading the surface of the glass through stain/haze and/or pitting. Furthermore, glass components such as corrosive sodium may be harmful to the materials of the mold body. The coatings described herein mitigate these problems.

The outermost layer of the multi-layer coating 110 is a glass-contacting layer 112. The glass-contacting layer 112 makes contact with heated glass at the glass-contacting surface 124 during glass-shaping. In some embodiments, the glass-contacting layer 112 may comprise metal oxides, such as, but not limited to, titanium oxide, aluminium oxide, or combinations thereof. As used herein to describe any layer of the multi-layer coating, “titanium oxide” means an oxide of titanium in any oxidation state, such as, but not limited to, TiO₂, TiO, Ti₂O₃, or combinations thereof. As used herein to describe any layer of the multi-layer coating, “aluminium oxide” means an oxide of aluminium in any oxidation state, such as, but not limited to, Al₂O₃, Al₂O, AlO, or combinations thereof. In one embodiment, the glass-contacting layer 112 may comprise mixed titanium oxide and aluminium oxide. The mixed titanium oxide and aluminium oxide may have sodium diffusivity to a depth of greater than or equal to about 20 nm. In some embodiments, the mixed titanium oxide and aluminium oxide layer may have sodium diffusivity to a depth of greater than or equal to about 30 nm. In one embodiment, the glass-contacting layer 112 may comprise greater than or equal to about 1% sodium by mass at a depth of about 20 nm from the glass contacting surface 124. In another embodiment, the glass-contacting layer 112 may comprise greater than or equal to about 2% sodium by mass at a depth of about 10 nm from the glass contacting surface 124. The sodium diffusivity of the mixed titanium oxide and aluminium oxide may prevent sodium accumulation on the outer surface of the multi-layer coating 110, which reduces staining, scuffing, and/or pitting on the molded glass.

In some embodiments, the glass-contacting layer 112 may comprise a molar ratio of Ti to Al (Ti:Al) of greater than or equal to about 0.3:1 and less than or equal to about 3:1. In an exemplary embodiment, the glass-contacting layer 112 may comprise a molar ratio of Ti to Al (Ti:Al) of greater than or equal to about 0.5:1 and less than or equal to about 2:1. In another exemplary embodiment, the glass-contacting layer 112 may comprise a molar ratio of Ti to Al (Ti:Al) of greater than or equal to about 0.6:1 and less than or equal to about 1.5:1. As used herein, the molar ratio of Ti to Al refers to the molar ratio of all atoms of Ti and Al, respectively, whether in a non-bound atomic form or bound with other atoms to form molecules.

In one embodiment, the outermost portion of the glass-contacting layer 112 may comprise platelet like titanium oxide, such as titanium oxide in a rutile phase crystal structure (sometimes referred to herein as “rutile”). The rutile phase titanium oxide may have aluminium oxide defects incorporated in its structure. The rutile may be dispersed in a titanium oxide and aluminium oxide mixed oxide layer. Without being bound by theory, it is believed that a titanium oxide enriched outer layer, such as rutile formed at the outer surface of the glass-contacting layer 112, may have the advantage of not forming low liquidus phases with Na₂O—Al₂O₃—SiO₂. Titanium oxide is also not a glass former, so the potential for glass sticking to the coating is reduced. Additionally, platelet like titanium oxide morphology of the coating has lubricating properties which may minimize glass scuffing of the coated mold 100, as well as staining and pitting. Titanium oxide enriched surfaces may extend the service life of the coating thereby improving the durability of the multi-layer coating 110. As used herein, an “enriched” layer comprises a higher percentage of a selected chemical species than any other chemical species. For example, “titanium oxide enriched” layer may have titanium oxide as its most abundant chemical species. In some embodiments, the glass-contacting layer 112 may comprise elemental nitrogen or nitrides, such as TiAlN, TiAlSiN, or combinations thereof. However, the glass-contacting layer 112 may generally have a molar nitrogen content of less than about 30%. As used herein, the molar nitrogen content refers to the molar percentage of nitrogen in a layer, where nitrogen may be in a non-bound atomic form or bound with other atoms to form molecules, such as nitrides.

In another embodiment, the outer portion of the glass-contacting layer 112 may comprise an aluminium oxide and titanium oxide mixed layer at the outer portion of the glass-contacting layer 112 (nearest the glass contacting surface) and may comprise a titanium oxide enriched layer at the inner portion of the glass-contacting layer 112 (nearest the diffusion barrier layer 116). In yet another embodiment, the outer portion of the glass-contacting layer 112 may comprise a titanium oxide enriched layer at the outer portion of the glass-contacting layer 112 (nearest the glass contacting surface 124) and may comprise an aluminium oxide enriched layer at the inner portion of the glass-contacting layer 112 (nearest the diffusion barrier layer 116). In yet another embodiment, the outer portion of the glass-contacting layer 112 may comprise an aluminium oxide enriched layer at the outer portion of the glass-contacting layer 112 (nearest the glass contacting surface 124) and may comprise a titanium oxide enriched layer at the inner portion of the glass-contacting layer 112 (nearest the diffusion barrier layer 116).

Generally, the components of the glass-contacting layer 112, such as, but not limited to, titanium, aluminum, or combinations thereof, may be deposited in a non-oxidized form, and may be oxidized by a heat treatment to form titanium oxide, aluminum oxide, or combinations thereof, as described herein. As such, in some embodiments, the thickness of the glass-contacting layer 112 may be greater following the heat treatment than before the heat treatment. In one embodiment, prior to the heat treatment the glass-contacting layer 112 may have a thickness of greater than or equal to about 25 nm and less than or equal to about 2000 nm. In an exemplary embodiment, prior to the heat treatment the glass-contacting layer 112 may have a thickness of greater than or equal to about 100 nm and less than or equal to about 1000 nm. In another exemplary embodiment, prior to the heat treatment the glass-contacting layer 112 may have a thickness of greater than or equal to about 200 nm and less than or equal to about 400 nm. In one embodiment, following the heat treatment the glass-contacting layer 112 may have a thickness of greater than or equal to about 25 nm and less than or equal to about 2000 nm. In an exemplary embodiment, the glass-contacting layer 112, following the heat treatment the glass-contacting layer 112 may have a thickness of greater than or equal to about 100 nm and less than or equal to about 1000 nm. In another exemplary embodiment, following the heat treatment the glass-contacting layer 112 may have a thickness of greater than or equal to about 300 nm and less than or equal to about 500 nm.

The diffusion barrier layer 116 is positioned between the glass-contacting layer 112 and the mold body 120. In one embodiment, the diffusion barrier layer 116 may comprise a nitride, such as TiAlN, TiAlSiN, or combinations thereof. The diffusion barrier layer 116 may generally have a molar nitrogen content of greater than about 30%. The diffusion barrier layer 116 may restrict diffusion of base metals from the mold body 120 to the glass-contacting layer 112. As noted herein, base metals from the mold body 120, such as Ni or Cr, may be mobile at elevated temperatures, and their presence in the glass-contacting layer 112 may cause defects, such as pitting. Additionally, the diffusion barrier layer 116 may also restrict diffusion of glass materials from the glass-contacting layer 112 to the mold body 120. Some glass materials, such as sodium, may cause corrosion in the material of the mold body 120. As the diffusion barrier layer 116 prevents the diffusion of these species, the diffusion barrier layer 116 prevents defects caused by such species.

The diffusion barrier layer 116 may also prevent the formation of voids in the mold body 120 that are due to the outdiffusion of base metals into the multi-layer coating 110. Specifically, the diffusion barrier layer 116 prevents the diffusion of base metals into the glass-contacting section of the multi-layer coating 110 and, as a result, mitigates the formation of voids in the mold body 120 that are left by out-diffused metal. Since voids may form with less severity and/or frequency with a diffusion barrier layer 116, the diffusion barrier layer 116 may enable repeat stripping and recoating of molds, and extends the service life of the mold.

In some embodiments, the diffusion barrier layer may not substantially change in thickness from exposure to the heat treatment. In one embodiment, prior to or following the heat treatment the diffusion barrier layer 116 may have a thickness of greater than or equal to about 25 nm and less than or equal to about 2000 nm. In an exemplary embodiment, prior to or following the heat treatment the diffusion barrier layer 116 may have a thickness of greater than or equal to about 100 nm and less than or equal to about 600 nm. In another exemplary embodiment, prior to or following the heat treatment the diffusion barrier layer 116 may have a thickness of greater than or equal to about 300 nm and less than or equal to about 500 nm.

In some embodiments, the multi-layer coating 110 may optionally comprise an adhesion layer 118, as shown in FIG. 2. The adhesion layer 118 may be in contact with the mold body 120 and positioned between the diffusion barrier layer 116 and the mold body 120. The adhesion layer 118 may generally be a non-oxidized metal. For example, in embodiments, the adhesion layer 118 may comprise TiAl, Al, Ti, or combinations thereof. The adhesion layer 118 may provide enhanced adhesion between the mold body 120 and the diffusion barrier layer 116. Additionally, the adhesion layer 118 may generally smooth the surface of the mold body 120, filling pits and other defects which may interfere with the deposition of at least the diffusion barrier layer 116. It should be understood that the adhesion layer 118 is optional and that, in some embodiments, the multi-layer coating 110 may be formed without the adhesion layer 118.

Generally, the components of the adhesion layer 118, such as, but not limited to, titanium, aluminum, or combinations thereof, may be deposited in a non-oxidized form, and during the heat treatment, materials from the mold body 120 may diffuse into the adhesion layer 118. As such, in some embodiments, the thickness of the adhesion layer 118 may be greater following the heat treatment than before the heat treatment. In one embodiment, prior to the heat treatment the adhesion layer 118 may have a thickness of greater than or equal to about 10 nm and less than or equal to about 2000 nm. In an exemplary embodiment, prior to the heat treatment the adhesion layer 118 may have a thickness of greater than or equal to about 30 nm and less than or equal to about 300 nm. In another exemplary embodiment, prior to the heat treatment the adhesion layer 118 may have a thickness of greater than or equal to about 100 nm and less than or equal to about 200 nm. In one embodiment, following the heat treatment the adhesion layer 118 may have a thickness of greater than or equal to about 10 nm and less than or equal to about 1000 nm. In an exemplary embodiment, following the heat treatment the adhesion layer 118 may have a thickness of greater than or equal to about 30 nm and less than or equal to about 300 nm. In another exemplary embodiment, following the heat treatment the adhesion layer 118 may have a thickness of greater than or equal to about 100 nm and less than or equal to about 200 nm.

In some embodiments, the multi-layer coating 110 may optionally comprise a transition layer 114. The transition layer 114 may be positioned between the glass-contacting layer 112 and the diffusion barrier layer 116. The transition layer 114 may comprise gradient-reduced nitrogen. Specifically, there may be higher molar nitrogen content in the portion of the transition layer 114 closest to the diffusion barrier layer 116 and lower or no molar nitrogen content in the portion of the transition layer 114 closest to the glass-contacting layer 112. For example, the part of the transition layer 114 nearest the diffusion barrier layer 116 may comprise a nitride, such as TiAlN. The nitride in the transition layer 114 may be the same nitride contained in the diffusion barrier layer 116. On the side of the transition layer 114 closest to the glass-contacting layer 112, there may be less or no nitrogen present. For example, nearest the glass-contacting layer 112, the transition layer 114 may comprise mostly TiAl, or oxides thereof, and nearest the diffusion barrier layer 116 the transition layer 114 may comprise mostly TiAlN. In one embodiment, the portion of the transition layer 114 in contact with the diffusion barrier layer 116 may comprise at least about 20% molar nitrogen content and the portion of the transition layer 114 closest to the glass-contacting layer 112 may not contain nitrogen. Without being bound by theory, it is believed that the transition layer 114 may reduce the mechanical stress in the multi-layer coating 110, especially as compared with a coating which has nitride and non-nitride layers in direct contact. Since different chemical species in the multi-layer coating 110 may have different coefficients of thermal expansion, the mechanical stress between layers of the multi-layer coating 110 can be reduced by forming a layer that utilizes a gradient of a chemical species to reduce mechanical stress during heating a cooling. In one embodiment, the transition layer 114 may comprise a molar nitrogen content of greater than about 30% at its surface nearest the diffusion barrier layer 116 and a molar nitrogen content of less than about 30% at its surface nearest the glass-contacting layer 112. In another embodiment the transition layer 114 may comprise a nitrogen composition of greater than about 35% at its surface nearest the diffusion barrier layer 116 and a nitrogen composition of less than about 25% at its surface nearest the glass-contacting layer 112. In another embodiment the transition layer 114 may comprise a nitrogen composition of greater than about 40% at its surface nearest the diffusion barrier layer 116 and a nitrogen composition of less than about 20% at its surface nearest the glass-contacting layer 112. It should be understood that the transition layer 114 is optional and that, in some embodiments, the multi-layer coating 110 may be formed without the transition layer 114.

Generally, the components of the transition layer 114, such as, but not limited to, titanium, aluminum, or combinations thereof, may be deposited in a non-oxidized form, and may be oxidized by a heat treatment to form titanium oxide, aluminum oxide, or combinations thereof, as described herein. As such, in some embodiments, the thickness of the transition layer 114 may be greater following the heat treatment than before the heat treatment. In one embodiment, prior to the heat treatment the transition layer 114 may have a thickness of greater than or equal to about 25 nm and less than or equal to about 2000 nm. In an exemplary embodiment, prior to the heat treatment the transition layer 114 may have a thickness of greater than or equal to about 100 nm and less than or equal to about 800 nm. In another exemplary embodiment, prior to the heat treatment the transition layer 114 may have a thickness of greater than or equal to about 200 nm and less than or equal to about 500 nm. In one embodiment, following the heat treatment the transition layer 114 may have a thickness of greater than or equal to about 25 nm and less than or equal to about 2000 nm. In an exemplary embodiment, following the heat treatment the transition layer 114 may have a thickness of greater than or equal to about 50 nm and less than or equal to about 700 nm. In another exemplary embodiment, following the heat treatment the transition layer 114 may have a thickness of greater than or equal to about 100 nm and less than or equal to about 400 nm.

In some embodiments, coating improvements can be achieved by incorporating other non-glass forming components into the structure of the coating to enhance the anti-stick behavior of the coating. Such chemical components, for example, include, Zr, Ni, Y and/or Hf. These non-glass forming components may be present in any or all of the glass-contacting layer 112, diffusion barrier layer 116, transition layer 114, and adhesion layer 118.

Generally, a coated mold 100 may be prepared by depositing the various coating layers onto the mold body 120 using a deposition technique, such as physical vapor deposition (PVD). However, other known deposition techniques may be used. To prepare the coated mold 100, at least a diffusion barrier layer 116 is deposited on of the forming surface 122 and at least a glass-contacting layer 112 is deposited over the diffusion barrier layer 116. Various layers of the multi-layer coating 110, as described herein, may be deposited sequentially, beginning with the layer in direct contact with the mold body 120 and ending with the glass-contacting layer 112 positioned as the outermost layer of the multi-layer coating 110. For example, in one embodiment, a PVD preparation process may comprise PVD sputtering of layers of the multi-layer coating 110 at elevated temperature (greater than 250° C., or even greater than 450° C.), high target power (greater than 2 kW) and substrate bias (80-150 V).

Following the layer deposition, the coated mold may be heat treated for a time and at a temperature sufficient to oxidize at least a portion of the multi-layer coating, such as, for example, heated to a temperature of at least about 500° C., at least about 600° C., at least about 700° C., or even at least about 750° C. For example, the coating may be heat treated by heating at a rate of 2° C./min from 20° C. to 750° C., holding at 750° C. for 30 min, and cooled to room temperature (i.e., about 25° C.) at furnace rate. However, other temperature ramping rates and maximum heating temperatures are contemplated herein. In one embodiment, the multi-layer coating is heat treated by exposure to elevated temperatures in a heating device, such as an oven or kiln. In another embodiment, the multi-layer coating may be heat treated by direct exposure to glass at an elevated temperature, such as direct contact with the glass that is being molded. However, any suitable heating process may be performed.

### EXAMPLES

The embodiments of the coatings for glass-shaping molds described herein will be further clarified by the following examples. The examples are illustrative in nature, and should not be understood to limit the subject matter of the present disclosure.

### Example 1

A dense superlattice of TiAlN was deposited on a mold using 3 targets with a Ti:Al ratio of about 1:1, and one target with Ti:Al ratio less than about 1:1, which created a diffusion barrier layer having a structure of alternating Ti rich and Al rich layers with superior high temperature resistance and hardness. The superlattice coating thickness was about 300 nm to about 2000 nm. At the end of deposition, deposition of Al rich target discontinued and a Ti rich layer 50-500 nm thick was deposited, having a thickness of about 50 nm to about 300 nm. The Ti/Al atomic ratio of this top layer was between about 0.7 and 1.2. The mold was then heat treated by heating at a rate of 2° C./min from 20° C. to 750° C., holding at 750° C. for 30 min, and cooling to room temperature at furnace rate. The heat treatment promoted deeper oxidation prior to reacting with glass and stabilized mold emissivity.

### Example 2

A dense superlattice of TiAlN was deposited using 3 targets with a Ti:Al ratio of about 1:1, and one target with Ti:Al ratio less than about 1:1 to form a diffusion barrier layer. The superlattice coating thickness was about 300 nm to about 2000 nm. At the end of the deposition, N₂ was gradually turned off during the last stage of TiAlN to create a graded TiAlN/TiAl transition layer. The graded layer was about 30 nm to about 150 nm thick. The graded layer resulted in non-stoichiometric N containing TiAlN coating. The presence of N promoted aluminium oxide dominant scale formation on oxide top, as compared with TiAl alloy that, after oxidation, formed well mixed titanium oxide and aluminium oxide. So by reducing N, the formation of either titanium oxide enriched or well mixed titanium oxide and aluminium oxide top layer was promoted. The incorporation of nitrogen in a transition layer reduced the stress in the coating and improved its high temperature stability. Additional TiAl layers were sputtered on top of the graded layer at a thickness between 0 nm to 2000 nm to increase the thickness of oxidized layer permeable to Na₂O. The mold was then heat treated by heating at a rate of 2° C./min from 20° C. to 750° C., holding at 750° C. for 30 min, and cooling to room temperature at furnace rate. The heat treatment promoted deeper oxidation prior to reacting with glass and stabilized mold emissivity.

### Example 3

A 30 nm-300 nm thick TiAl coating was deposited on a base metal mold to form an adhesion layer. On top of this coating, a TiAlN layer having a thickness of 100 nm-3000 nm was deposited. Then, a TiAl layer with graded nitrogen having a thickness of 30-300 nm was deposited to form a transition layer, followed by 30-2000 nm thick TiAl layer as the glass-contacting layer. The mold was then heat treated by heating at a rate of 2° C./min from 20° C. to 750° C., holding at 750° C. for 30 min, and cooled to room temperature at furnace rate. The heat treatment promoted deeper oxidation prior to reacting with glass and stabilized mold emissivity.

It should now be understood that the coatings disclosed herein may offer the advantage of reduced stickiness between the mold and the glass, thus reducing or wholly eliminating cosmetic defects in molded glass, such as stains, pitting, and scuffing. The coatings described herein may also have enhanced durability, and may allow for extending mold life to at least 500 cycles before the coating must be stripped and reapplied to the mold.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Various modifications and variations can be made to the embodiments described herein without departing from the scope of the claimed subject matter. Thus it is intended that the specification cover the modifications and variations of the various embodiments described herein provided such modification and variations come within the scope of the appended claims and their equivalents.

We claim:

1. A multi-layer coating for a glass-shaping mold, the multi-layer coating comprising:
a glass-contacting layer that makes contact with glass during glass-shaping, the glass-contacting layer comprising titanium oxide, aluminium oxide, or combinations thereof; and
a diffusion barrier layer positioned between the glass-contacting layer and a mold body, wherein the diffusion barrier layer restricts diffusion of base metals from the mold body to the glass-contacting layer and diffusion of glass materials from the glass-contacting layer to the mold body.

2. The multi-layer coating of claim 1, wherein the glass-contacting layer comprises mixed titanium oxide and aluminium oxide.

3. The multi-layer coating of claim 1, wherein the glass-contacting layer comprises a molar ratio of Ti to Al (Ti:Al) of greater than or equal to about 0.3:1 and less than or equal to about 3:1.

4. The multi-layer coating of claim 1, wherein the diffusion barrier layer comprises a nitride.

5. The multi-layer coating of claim 1, wherein the diffusion barrier layer comprises TiAlN, TiAlSiN, or combinations thereof.

6. The multi-layer coating of claim 1, further comprising an adhesion layer in contact with the mold body and positioned between the diffusion barrier layer and the mold body.

7. The multi-layer coating of claim 6, wherein the adhesion layer comprises TiAl, Al, Ti, or combinations thereof.

8. The multi-layer coating of claim 1, further comprising a transition layer positioned between the glass-contacting layer and the diffusion barrier layer, the transition layer comprising gradient-reduced nitrogen with a higher molar nitrogen content in a portion of the transition layer closest to the diffusion barrier layer and a lower or no molar nitrogen content in a portion of the transition layer closest to the glass-contacting layer.

9. The multi-layer coating of claim 8, wherein the transition layer comprises a molar nitrogen content of greater than about 30% at its surface nearest the diffusion barrier layer and a molar nitrogen content of less than about 30% at its surface nearest the glass-contacting layer.

10. The multi-layer coating of claim 1, wherein the glass-contacting layer comprises titanium oxide in a rutile phase.

11. The multi-layer coating of claim 1, wherein the glass-contacting layer comprises greater than or equal to about 1% sodium by mass at a depth of about 20 nm.

12. The multi-layer coating of claim 1, wherein the glass-contacting layer, the diffusion barrier layer, or both, comprise Zr, Ni, Y, Hf, or combinations thereof.

13. A coated mold for shaping glass, the coated mold comprising a mold body and a multi-layer coating, and wherein the multi-layer coating comprises:
a glass-contacting layer that makes contact with glass during glass-shaping, the glass-contacting layer comprising titanium oxide, aluminium oxide, or combinations thereof; and
a diffusion barrier layer positioned between the glass-contacting layer and the mold body, wherein the diffusion barrier layer restricts both diffusion of base metals from the mold body to the glass-contacting layer and diffusion of glass materials from the glass-contacting layer to the mold body.

14. The coated mold of claim 13, wherein the multi-layer coating further comprises:
an adhesion layer in contact with the mold body and positioned between the diffusion barrier layer and the mold body; and
a transition layer positioned between the glass-contacting layer and the diffusion barrier layer, the transition layer comprising gradient-reduced nitrogen with a higher molar nitrogen content in a portion of the transition layer closest to the diffusion barrier layer and a lower or no molar nitrogen content in a portion of the transition layer closest to the glass-contacting layer.

15. The coated mold of claim 14, wherein the transition layer comprises a molar nitrogen content of greater than about 30% at its surface nearest the diffusion barrier layer and a molar nitrogen content of less than about 30% at its surface nearest the glass-contacting layer.

16. The coated mold of claim 13, wherein:
the glass-contacting layer comprises mixed titanium oxide and aluminium oxide; and
the diffusion barrier layer comprises a nitride.

17. The coated mold of claim 16, wherein the diffusion barrier layer comprises TiAlN, TiAlSiN, or combinations thereof.

18. A process for making a coated mold for shaping glass, the process comprising depositing a multi-layer coating onto at least a portion of a forming surface of a mold body, wherein depositing the multi-layer coating comprises:
depositing a diffusion barrier layer, wherein the diffusion barrier layer is positioned between a glass-contacting layer and the mold body, and wherein the diffusion barrier layer restricts diffusion of base metals from the mold body to the glass-contacting layer and diffusion of glass materials from the glass-contacting layer to the mold body;
depositing the glass-contacting layer, wherein the glass-contacting layer comprises titanium, aluminium, or combinations thereof; and
heat treating the coated mold by heating for a time and at a temperature sufficient to oxidize at least a portion of the multi-layer coating.

19. The process of claim 18, wherein following the heat treatment, the glass-contacting layer comprises titanium oxide, aluminium oxide, or combinations thereof.

20. The process of claim 18, wherein the diffusion barrier layer and the glass-contacting layer are deposited by physical vapor deposition.
